(19) United States
(12) Patent Application Publication
(10) Pub. No.: US 2006/0002425 A1
(43) Pub. Date: Jan. 5, 2006

(54) Determining available bandwidth in a network

(76) Inventors: Pravin D. Mane, Hillsboro, OR (US); Ajit P. Joshi, Portland, OR (US); Yeugeniy Epshteyn, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,107

(22) Filed: Jun. 30, 2004

(51) Int. Cl. H04J 3/18

(52) U.S. Cl. 370/477; 370/332

(57) ABSTRACT

A number of probe messages are formed in a first node of a network, to be sent to a second node of the network. Reply messages received from the second node are monitored in the first node, to detect a loss. The loss is a failure to receive a predetermined number of one or more reply messages that correspond to the probe messages. Available bandwidth is then determined, for communicating in the network with the second node, based on the detected loss. Other embodiments are also described and claimed.

### BACKGROUND

An embodiment of the invention is related to techniques for measuring network bandwidth. Other embodiments are also described.

With the advent of high performance processors such as the Pentium 4® processor by Intel Corp., Santa Clara, Calif., it is now easier to stream video and audio data packets in the digital home environment. This environment is a relatively small network of electronic devices that communicate with each other (via cable or wireless links) to fulfill the needs of home users. Such devices include for example the personal computer (PC, a desktop or notebook version), television set-top boxes, high definition digital television (HDTV) receivers, mobile phones, personal digital assistants, and kitchen appliances. These devices have to share network resources such as a network interface controller, a router, and a wireless or cable link. For example, consider the situation where a desktop PC implements a node that is at the center of a home network and acts a router to direct data packets from any source node to a destination node. Assume this desktop PC is connected to a HDTV receiver, and is recording a previously programmed television show by receiving and storing a video stream from the HDTV receiver. At the same time, the desktop PC is connected to the Internet, and another person is browsing the Web on a rendering device such as a wireless notebook PC that is connected to the desktop PC by a wireless link. In such a scenario, network resources such as the central processing unit (CPU), main memory, network interface controller (NIC), and mass storage device (e.g., hard drive) of the desktop PC are being shared by different application programs running in the desktop PC.

The increased sharing of network resources, due to for example multiple rendering devices and application programs running at the same time in the network, calls for better management of network bandwidth. Network bandwidth, also referred to as throughput, is the amount of data that can be transferred between two nodes of a network, in a given interval. Sharing results in less bandwidth being available for other applications and devices. Certain applications such as video and audio streams are time sensitive and therefore need a minimum, available bandwidth that is sustained for a relatively long interval. This helps provide a better experience to the user, e.g. fewer dropped data packets resulting in the playback of cleaner sound and smoother motion at the rendering device. Other applications such as leisurely Web browsing have generally low bandwidth requirements except for some randomly occurring and relatively brief intervals during which detailed images are downloaded. Thus, before allowing an application that has a relatively strong and sustained demand for bandwidth to run freely, a measure of the available bandwidth in the network should be taken to see if the application can be expected to run smoothly.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a digital home environment.

FIG. 2 shows how two end nodes having a layered architecture are organized and connected by one or more nodes within the network.

FIGS. 3 and 4 show protocol graphs for an Internet architecture.

FIG. 5 shows a flow diagram of a method for operating in a network, for measuring or probing network bandwidth.

FIG. 6 shows a flow diagram of a method for measuring network bandwidth, where the probe messages used are ICMP echo messages.

FIG. 7 illustrates a flow diagram of a method for determining a path maximum transferable unit (MTU).

### DETAILED DESCRIPTION

Techniques for operating in a network are described, for measuring or probing network bandwidth. In an embodiment of the invention, available bandwidth is determined for communicating in the network with another node, based on a detected “loss”. This loss is a failure to receive a predetermined number of one or more reply messages that correspond to a number of probe messages that have been sent to the second node. Other embodiments are also described.

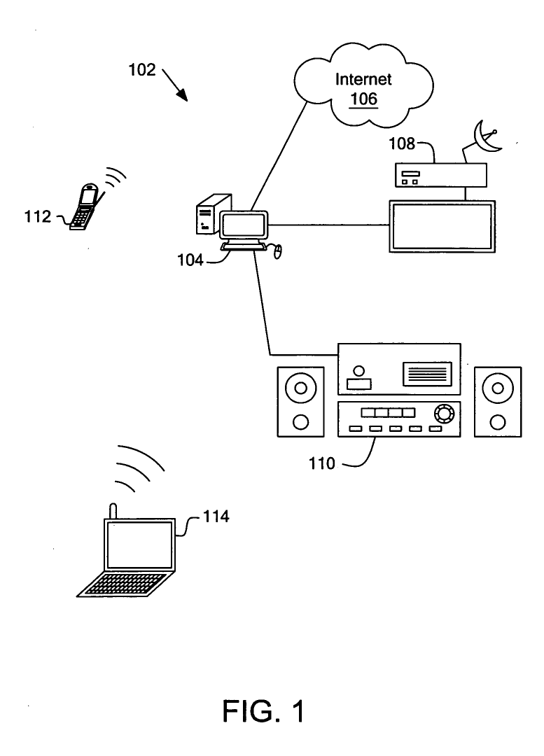

Turning now to FIG. 1, a digital home environment 102 is shown in which the bandwidth measurement techniques may be implemented. The various network devices in this example network include a desktop PC 104, an HDTV receiver 108, a high fidelity audio system 110, a cellular telephone 112, and a notebook PC 114. Each of these network devices implements a node of the home environment 102. Some of these devices are referred to as “end nodes” or “endpoints” where network data traffic typically stops. These could include the cellular telephone 112 and the audio system 110. In contrast, the desktop PC 104 may serve as a router, to connect with the Internet 106 and direct data traffic between end nodes.

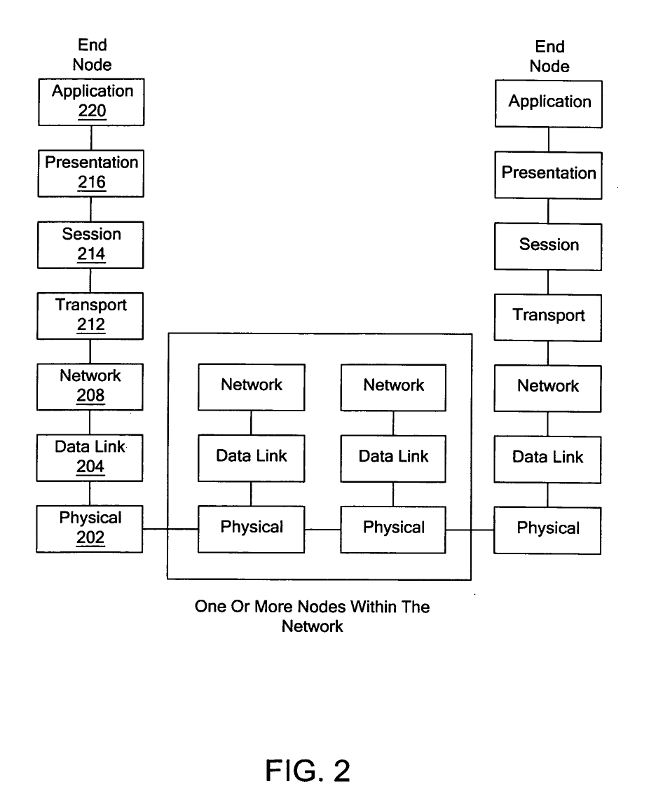

The digital home environment 102 operates as a layered network system. FIG. 2 shows how two end nodes may be organized with a layered architecture and connected by one or more nodes within the network. Each protocol layer defines two different interfaces. First, there is a service interface to other objects that are in the same node that wish to use its services. Second, a protocol layer also has a peer interface to its counter part (peer) on another machine. This interface describes the form and meaning of messages exchanged between protocol peers to implement a communication service between nodes. Higher layers may be added, to provide additional services on top of the lower layers. In other words, these additional services will use the service interface of the lower layers, to communicate with a corresponding protocol layer in another end node. Such layering decomposes the problem of building the network into more manageable components. In addition, it provides a more modular design, so that if additional services are to be added, the functionality at the desired layer may be modified while reusing the functions provided in all of the other layers.

Still referring to FIG. 2, the network functionality is in this case partitioned into seven layers where one or more protocols implement the functionality assigned to a given layer. The lowest layer is the physical layer 202 that handles the transmission of raw bits over a communications link. Note that as used here, a “bit” refers to two or more states in each data unit that is transferred, e.g. binary bits, ternary bits. The data link layer 204 collects a stream of bits into a larger aggregate called a frame. Network adapters also referred to as network interface controllers (NICs) along with device drivers running in the operating system of an end node typically implement the data link level. This means that frames, not raw bits, are actually delivered to the upper layer functionality referred to sometimes as the “host”.

Above the data link layer 204 lies the network layer 208 which handles routing among nodes within a packet-switched network. At this layer, the unit of data exchanged among nodes is typically called a packet rather than a frame, although fundamentally they may be the same thing. These lower three layers may be implemented on all network nodes, including routers and switches, as well as end nodes connected along the exterior of the network.

Next is the transport layer 212 which implements what is also referred to as a process-to-process logical channel between the higher level functionality in different end nodes. Here the unit of data that is exchanged is more commonly referred to as a message, rather than a packet or frame. The transport layer and higher layers (e.g., the session and presentation layers 214, 216) are typically run only on end nodes, and not on intermediate switches or routers. At the top is the application layer 220 which may include protocols such as a file transfer protocol (FTP).

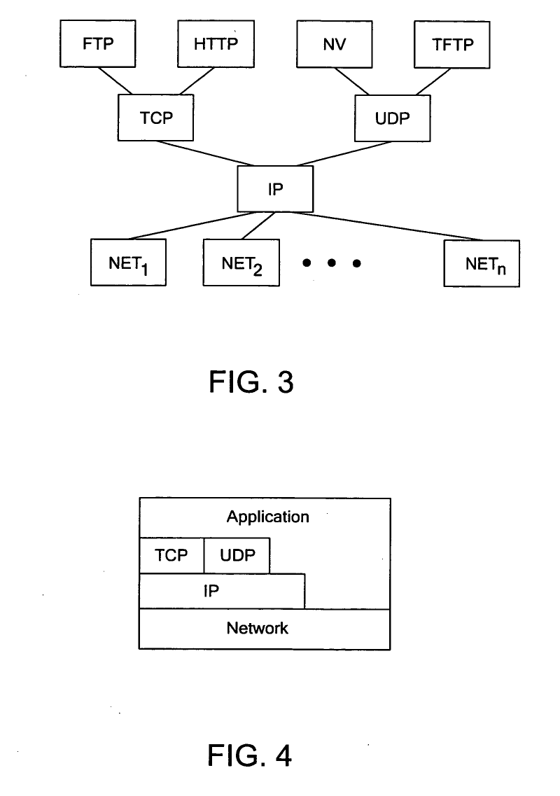

Turning now to FIGS. 3 and 4, what is shown are protocol graphs for an Internet architecture, sometimes referred to as the TCP/IP architecture after its two main protocols transmission control protocol and Internet protocol. In this case, rather than the seven layer model of FIG. 2, a four layer mode is used instead. At the lowest level are a variety of network protocols denoted NET₁, NET₂, . . . . In practice, these protocols are implemented by a combination of hardware (e.g., network adapter) and software (e.g., a network device driver). For example, this layer may implement an Ethernet or fiber distributed data interface (FDDI) protocol. The second layer has a single protocol, the Internet protocol (IP). This protocol supports the interconnection of multiple networking technologies into a single, logical inter network. The third layer contains two main protocols, namely the transmission control protocol (TCP) and the user datagram protocol (UDP). TCP and UDP are alternative logical channels to application programs. In the language of the Internet, TCP and UDP are sometimes called end-to-end protocols, although it is also correct to refer to them as transport protocols.

Running above the transport layer are a range of application protocols such as FTP, TFTP (trivial file transport protocol), Telnet (remote login), and SMTP (simple mail transfer protocol, or electronic mail). These enable the interoperation of popular applications. Another application layer protocol is HTTP (hypertext transport protocol) which may be used by various different application programs to access a site on the Web. For streaming media applications such as motion picture experts group (MPEG) video, the application program running in a desktop PC could be a server with transcoding capability, i.e. changing formats from, for example, MPEG1 or Audio Video Interleave (AVI) to MPEG4. As to the rendering device, the application program could be a client for rendering MPEG4 only, for example.

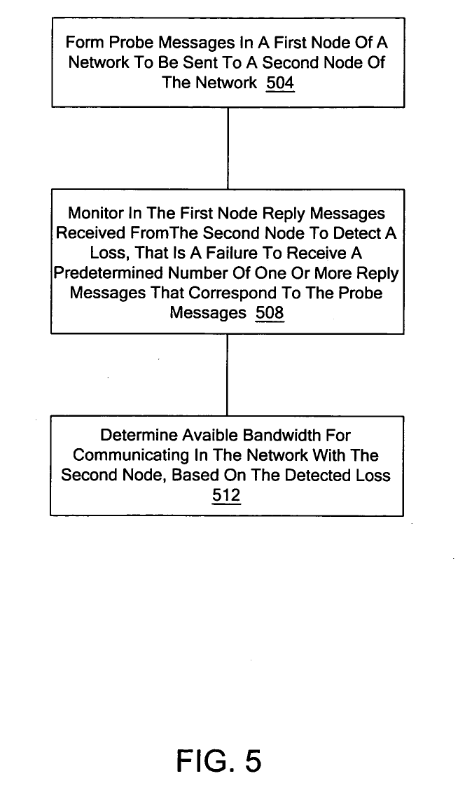

Turning now to FIG. 5, a flow diagram of a method for operating in a network, for measuring or probing network bandwidth is shown. This method may be performed in response to receiving a bit rate requirement from an application program that is running in a first node of the network. Operation begins with forming probe messages in the first node, to be sent to a second node of the network (block 504). Thereafter, reply messages that are received from the second node are monitored in the first node. This is done to detect a loss, that is a failure to receive a predetermined number of one or more reply messages that correspond to the probe messages (block 508). The available bandwidth for communicating within the network, with the second node, is then determined based on this detected loss (block 512). Thus, rather than rely solely on analyzing the linearity of a packet or message round trip time (RTT) with respect to its size, an indication of available bandwidth is determined based on the detected or measured loss of messages. For example, if ten probe messages were sent, and nine replies were received, then the available bandwidth would be deemed less than the current bit rate at which the probe messages were sent (provided, of course, that loss is defined to be the failure to receive at least one reply message). Note that bit rate in this case may be the rate at which the data link layer (or sometimes referred to as a media access controller, MAC) in the first node transmits data frames.

In the case where the network uses the IP layer architecture (FIGS. 3-4), each probe message may be an ICMP echo message which is a control message defined by the Internet control message protocol (ICMP). ICMP defines a collection of error messages which are typically sent back to a source host whenever a router or host is unable to process an IP datagram successfully. ICMP echo requests are an example of probe messages that have been formed above a transport layer of a network (e.g., see FIGS. 2-4), where in FIGS. 3 and 4, TCP and UDP are deemed to be protocols in the transport layer. Other types of messages that are formed above the transport layer of the network may, alternatively, be used. In such an embodiment, independence from the transport protocol layer allows the methodology to be available both during a streaming session, as well as at the start of (immediately prior to) the streaming session. Thus, the methodology described here may, when implemented above the transport protocol layer, be used essentially at any time, that is not limited to during a session that is already in progress, for estimating the bandwidth between two communicating devices in a network.

Each probe message should be designed to instruct the second node to form and send a reply message back to the first node, where in the case of ICMP echo requests and replies, both the request and reply are approximately the same size. According to another embodiment of the invention, a size of each probe message is based on the smallest, maximum data unit that can be transmitted in a single frame by a MAC of a network device that lies in a path between the first and second nodes. For example, if there are several intermediate nodes between the first and second nodes, a maximum data unit transmitted by each node is compared to the other maximum data units to determine which is the smallest. The size of the probe message is then determined based on this smallest, maximum data unit. An example of such a maximum data unit, also referred to as a maximum transferable unit (MTU), is the largest IP datagram that can be carried in a frame. Note that in this case, the value is smaller than the largest packet size on the network, because the IP datagram needs to fit in the payload of the data link layer frame. This is done so as to avoid fragmentation of the probe message as it travels the entire path from the first to the second node.

Thus, rather than ramp the size of the probe messages upwards as the method is measuring the network bandwidth, an embodiment of the invention instantly starts sending a largest possible probe message (while avoiding fragmentation). To avoid overwhelming the network with these probe messages, the first node is monitored for reply messages, such that if the number of reply messages received is less than the number of requests sent (within a predefined interval following the sending of the initial request), then the sending of probe messages is stopped. An indication may then be given to a higher layer that the available network bandwidth is probably less than the current bit rate at which the probe messages were being sent, because either the request or reply messages were lost in the network due to bandwidth saturation.

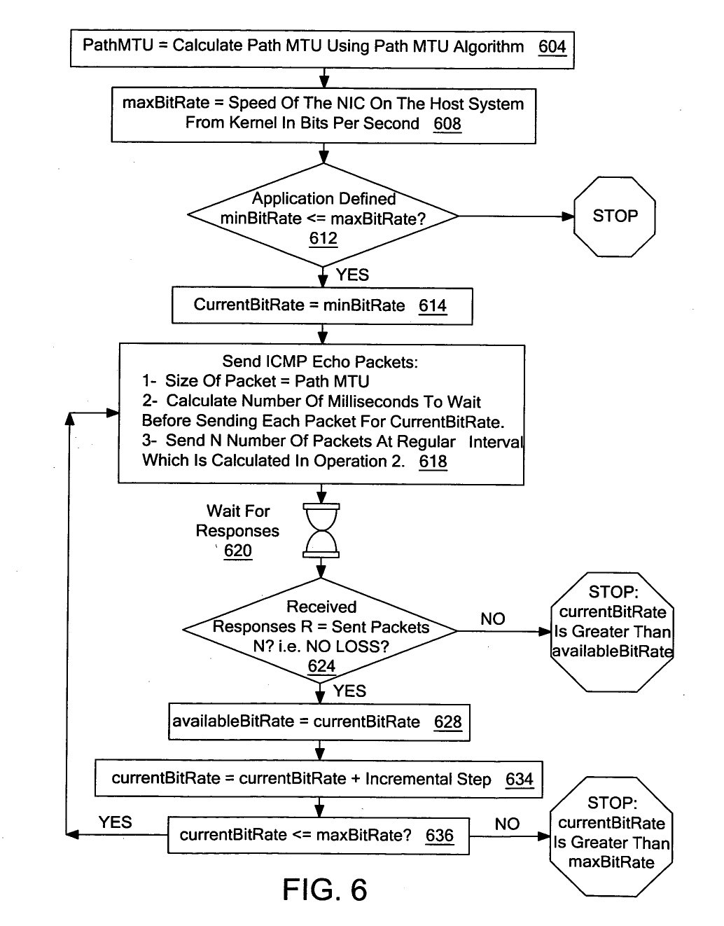

Turning now to FIG. 6, another embodiment of the invention is described by a flow diagram, where the probe messages used are ICMP echo messages (in this case referred to as ICMP echo “packets” since fragmentation is avoided). As will be described below, in this embodiment, a networking device which hosts media content, such as a digital movie or song recording, starts to inject ICMP echo requests in the network, towards a target, network rendering device. The injecting of the echo requests is done in a controlled manner so as not to overflow the resources of the network. Because of the way ICMP echo packets are designed, the targeted rendering device replies to these requests as they are received. As suggested above, in this case, the reply is the same size as the request, such that the same amount of data travels twice on the network between the host system and the rendering device. The host system monitors the amount of data that has been sent and received and then determines capacity of the network to transmit this amount of data, which is referred to as the available bandwidth between the two communicating devices.

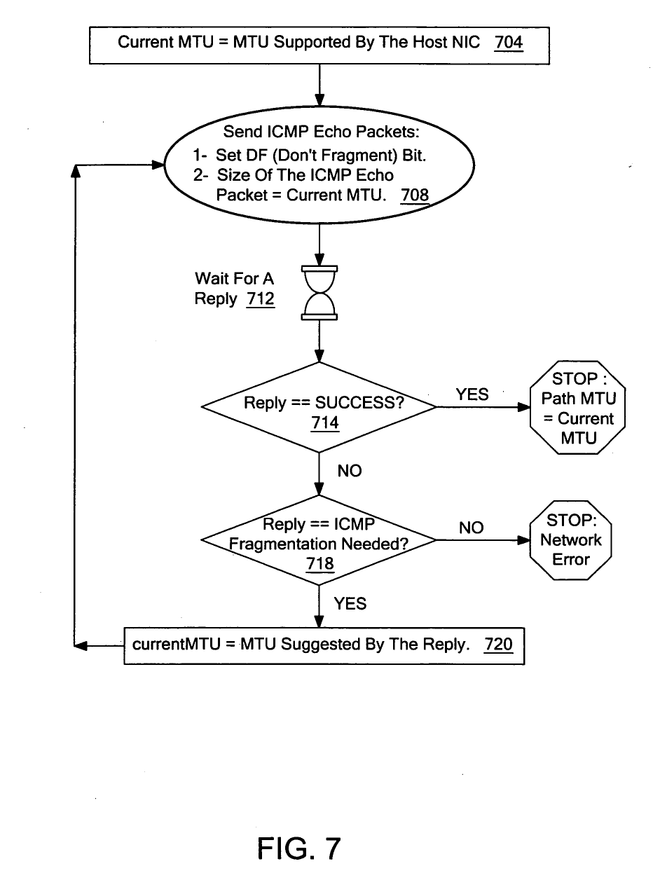

Operation in FIG. 6 begins with determining a path MTU for the targeted rendering device (block 604). That is because there may be different types of networking devices, such as a router or a wireless access point between the host and the rendering device, where each may have its own data link level constraints on transmissions. The smallest MTU supported between the host and the target rendering device (including MTUs of the host and the rendering device) is called the path MTU. This value may be calculated using an algorithm, as described below with reference to FIG. 7. The path MTU is used here to select the size of the ICMP echo request and reply, as described further below.

Operation then proceeds with obtaining the speed of the network interface controller (NIC) on the host system, for example, by querying the operating system kernel. This speed, also referred to as maximum bit rate, may be given in bits per second. Operation then proceeds with decision block 612, to determine whether an application-requested minimum bit rate is less than or equal to the maximum bit rate. If not, then the process is stopped and reported back to the requesting application. On the other hand, if the application-requested bit rate is less than or equal to the maximum, then the current bit rate of the host system is set to be the application-requested, minimum bit rate (block 614). Note that this action may not change the actual bit rate of the MAC in the NIC. ICMP echo packets are then formed and sent (block 618) at that rate. The size of an ICMP echo packet depends on the path MTU, and may be as follows: ICMP echo payload size=path MTU−sizeof (IP header)−sizeof (ICMP header). In addition, the interval between sending packets is calculated, and in this case as a number of milliseconds to wait before sending each packet, for the set value of the current bit rate.

These packets are sent, for the initial iteration, at a minimum speed which is in this case the requested minimum bit rate from the application program. The number of packets N that are sent in this case at regular intervals (calculated above) may be given by the following formula: Number of Packets (N) to send per time interval (T)=T*current rate bit rate being probed/path MTU, where the bit rate may be given in bits per second and the path MTU in bytes (scaling factors implied).

After the N packets are sent, the host system waits for responses (block 620), where the responses are in this case ICMP reply packets. If at the end of the waiting interval the received responses equal the sent packets (decision block 624) meaning that there was no loss, then the available bit rate is set to be the current bit rate (block 628). In other words, if the host finds that it has received replies to all of its requests, then it may conclude that this probed bandwidth (current bit rate) is a good one. Of course, if there is a loss that has been detected, then the process stops, because the current bit rate for transmitting data by the host is actually greater than the available bit rate in the network.

Returning to block 628, with no loss being detected, the host may then decide to probe at a higher bit rate, that is greater than the previous “good” current bit rate, to determine the bandwidth saturation point. Bandwidth saturation refers to the condition where a loss is first detected, as the current bit rate is increased. Thus, in block 634, the current bit rate is increased by an incremental step but without surpassing the maximum bit rate (block 636). The loop is then repeated with block 618, where a new number of packets (N) is computed that is to be sent per time interval T, followed by the sending of requests and the receiving of responses. This main loop may be repeated again with successively greater current bit rates until either a loss is detected or the maximum bit rate for transmission by the host system is reached, meaning that the last good bit rate is the available bit rate which the network can support.

The above-described process in FIG. 6 for measuring network bandwidth used a quantity referred to as a path MTU. FIG. 7 shows a flow diagram of an example method for calculating this value. This algorithm begins with block 704 in which a variable referred to as a current MTU is set equal to the MTU that is supported by the host NIC. An initial ICMP echo packet is formed in block 708, where the size of this packet is essentially equal to the current MTU, as given by the formula ICMP echo payload size=MTU−sizeof (IP header)−sizeof (ICMP header). In addition, a don't fragment (DF) bit of the ICMP header in the packet is set, before transmission, so as to instruct the networking devices in the path not to fragment the packet. The packet is then sent to its intended destination device, for example, the target rendering device, using the host NIC. The host then waits for a reply (block 712).

If a reply is received that has a success indication (block 714) then the path MTU has been found and is set to be the current MTU. The success indication in the reply message means that there has been no error message from any of the networking devices in the path, such that it may be assumed that none of these devices has a smaller MTU than the size of the ICMP echo request. On the other hand, if the reply does not indicate a success and has at least one or more error indications in it, then operation proceeds with decision block 718 to determine whether the reply includes an indication that ICMP fragmentation is needed. In that case, a networking device in the path may be using a smaller MTU than the size of the ICMP echo request, so that the host will select a smaller MTU as may be indicated by the error (block 720). The process then loops back to block 708 to form a new ICMP echo packet with the current MTU being set to a smaller size. The process may be repeated until the host receives a reply indicating success from the destination networking device. Other techniques for determining the path MTU may be used.

A computer program product or software may include a machine or computer-readable medium having stored thereon instructions which may be used to program a computer (or other electronic devices) to perform a process according to an embodiment of the invention described above. For example, the instructions may be part of a protocol stack layered between a device driver and an application program for a personal computer. In other embodiments, operations might be performed by specific hardware components that contain microcode, hardwired logic, or by any combination of programmed computer components and custom hardware components.

A machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

The invention is not limited to the specific embodiments described above. For example, although a digital home environment was used to illustrate the network bandwidth measurement techniques, these techniques may also be implemented in other types of packet-switched networks, including local area networks, wide area networks, enterprise networks, or other types of internets. Accordingly, other embodiments are within the scope of the claims.

What is claimed is:

1. A method for operating in a network, comprising:
a) forming a plurality of probe messages to be sent to a second node of the network; and
b) monitoring a plurality of reply messages received from the second node to detect a loss, wherein the loss is a failure to receive a predetermined number of one or more reply messages that correspond to the plurality of probe messages; and
c) determining available bandwidth for communicating in the network with the second node, based on the detected loss.

2. The method of claim 1 wherein determining the available bandwidth comprises:
setting an available bit rate to be less than a current bit rate in a data link layer of the first node if one or more reply messages that correspond to the plurality of probe messages are not received.

3. The method of claim 2 wherein the available bit rate is set to a fraction of the current bit rate, the fraction being the portion of the plurality of probe messages for which reply messages were received.

4. The method of claim 1 wherein determining the available bandwidth comprises:
setting an available bit rate to be approximately equal to a current bit rate in a data link layer of the first node if all reply messages that correspond to the plurality of probe messages are received.

5. The method of claim 1 wherein a size of each of the plurality of probe messages is set based on the smallest, maximum transferable unit (MTU) between the first and second nodes.

6. The method of claim 1 wherein a waiting interval between sending two probe messages is set so that transmission of the plurality of probe messages by the first node occurs at approximately a current bit rate of a data link layer of the first node.

7. The method of claim 6 wherein the plurality of probe messages are formed in response to a bit rate requirement from an application program, the method further comprising:
setting the current bit rate to be approximately the bit rate requirement from the application program.

8. The method of claim 6 further comprising:
setting the current bit rate to be approximately a bit rate requirement from an application program in the first node that will provide a stream of video and/or audio to be sent to the second node, if the bit rate requirement is less than a maximum bit rate of the data link layer in the first node.

9. The method of claim 4 further comprising:
increasing the current bit rate; and then
repeating a)-c) with the increased current bit rate.

10. The method of claim 1 wherein each of the plurality of probe messages is an ICMP echo request.

11. A system comprising:
a processor; and
memory containing instructions to be executed by the processor and that form part of a protocol stack layered between a device driver and an application program in the system,
the instructions when executed by the processor cause the system to form a plurality of probe messages to be sent to an endpoint of a network, wherein each of the probe messages instructs the endpoint to form and send a reply message back to the system, process reply messages received from the endpoint to measure whether the same number of reply messages that correspond to the plurality of probe messages has been received, and provide the application program an available bit rate based on the measurement, and wherein the instructions allow the system to form the plurality of probe messages and make the measurement at any one of (1) at the start of a streaming session, and (2) during a streaming session.

12. The system of claim 11 further comprising:
a network interface controller (NIC) having a current bit rate for transmitting packets by a media access controller (MAC) of the NIC,
wherein the plurality of probe messages are to be sent to the endpoint via the NIC,
and wherein the instructions are designed to set the available bit rate to be less than the current bit rate if one or more reply messages that correspond to the plurality of probe messages are not received.

13. The system of claim 12 wherein the instructions are designed to set the available bit rate to a fraction of the current bit rate, the fraction being the portion of the plurality of probe messages for which reply messages were received.

14. The system of claim 11 further comprising:
a network interface controller (NIC) having a current bit rate for transmitting packets by a media access controller (MAC) of the NIC, the plurality of probe messages to be sent to the endpoint via the NIC,
and wherein the instructions are designed to set the available bit rate to be approximately equal to the current bit rate if all reply messages that correspond to the plurality of probe messages are received.

15. The system of claim 11 wherein the instructions are designed to set a size of each of the plurality of probe messages based on the smallest, maximum data unit that can be transmitted in a single frame by a network device that lies in a path between the system and the endpoint.

16. The system of claim 15 further comprising:
a network interface controller (NIC) having a current bit rate for transmitting packets by a media access controller (MAC) of the NIC, the plurality of probe messages to be sent to the endpoint via the NIC,
and wherein a waiting interval between sending two probe messages is set so that transmission of the plurality of probe messages by the NIC occurs at approximately a current bit rate of the NIC.

17. An article of manufacture comprising:
a machine-accessible medium containing instructions that, when executed, cause a machine to determine a maximum transferable unit (MTU) of a path that connects a first node of a network to a second node of the network, form a plurality of probe messages above a transport layer of the network to be sent from the first node to the second node of the network, wherein each of the probe messages instructs the second node to form and send a reply message back to the first node, a size of each of the plurality of probe messages being based on the determined MTU, and provide an available bit rate for communication between the first and second nodes based on a detected failure of the first node to receive a predetermined number of one or more reply messages that correspond to the plurality of probe messages.

18. The article of manufacture of claim 17 wherein the instructions are such that the determined MTU is the smallest MTU in said path.

19. The article of manufacture of claim 18 wherein the instructions are such that instead of ramping up the size of each of the plurality of probe messages, the size of each of said plurality of probe messages is fixed.

20. The article of manufacture of claim 19 wherein the instructions are such that the size of each probe message is as large as possible without causing fragmentation by a media access controller (MAC) of the first node through which the probe messages are sent to the second node.

21. The article of manufacture of claim 17 wherein the instructions are part of a protocol stack layered between a device driver and an application program for a personal computer.

22. The article of manufacture of claim 21 wherein the medium contains further instructions that when executed query a network interface controller (NIC) for its maximum bit rate, and set a current bit rate of the NIC to a minimum requested bit rate from the application program that is less than the maximum bit rate.

23. The article of manufacture of claim 22 wherein the instructions are such that the number of said plurality of probe messages is selected based on the current bit rate and the determined MTU.

24. The article of manufacture of claim 22 wherein the instructions are such that the available bit rate is set be approximately equal to the current bit rate if all reply messages that correspond to the plurality of probe messages were received.

25. A method for operating in a network, comprising:
a) forming in a first node of the network a plurality of Internet Control Message Protocol (ICMP) echo requests to be sent to a second node of the network; and
b) monitoring in the first node a plurality of reply messages received from the second node to detect a loss, wherein the loss is a failure to receive a predetermined number of one or more reply messages that correspond to the plurality of Internet Control Message Protocol (ICMP) echo requests; and
c) determining available bandwidth for communicating in the network with the second node, based on the detected loss.

26. The method of claim 25 wherein determining the available bandwidth comprises:
setting an available bit rate to be less than a current bit rate in a data link layer of the first node if one or more reply messages that correspond to the plurality of ICMP echo requests are not received.

27. The method of claim 25 wherein determining the available bandwidth comprises:
setting an available bit rate to be approximately equal to a current bit rate in a data link layer of the first node if all reply messages that correspond to the plurality of ICMP echo requests are received.

28. The method of claim 25 wherein a size of each of the plurality of ICMP echo requests is set based on the smallest, maximum transferable unit (MTU) between the first and second nodes.

29. The method of claim 27 further comprising:
increasing the current bit rate; and then
repeating a)-c) with the increased current bit rate.
